(19) United States
(12) Patent Application Publication
(10) Pub. No.: US 2023/0318633 A1
(43) Pub. Date: Oct. 5, 2023

(54) DIGITAL RADIO WITH PROGRAMMABLE FREQUENCY PLAN EMULATOR

(71) Applicant: BAE Systems Information and Electronic Systems Integration Inc., Nashua, NH (US)

(72) Inventors: John E. Acheson, Anamosa, IA (US); Scott W. Stadelmann, Cedar Rapids, IA (US)

(73) Assignee: BAE Systems Information and Electronic Systems Integration Inc., Nashua, NH (US)

(21) Appl. No.: 17/655,082

(22) Filed: Mar. 16, 2022

(51) Int. Cl. H04B 1/00

(52) U.S. Cl. CPC H04B 1/0007; H04B 1/0089; H04B 1/0096

(57) ABSTRACT

A digital radio includes an input configured to receive an input signal and an analog-to-digital converter (ADC) configured to sample analog data in the input signal into a digital input signal. The digital input signal has first digital data encoded at a first data rate modulated at a first frequency. The digital radio further includes a signal processor configured to generate, based on the digital input signal, a digital output signal having second digital data encoded at a second data rate modulated at a second frequency. The first data rate is different from the second data rate and/or the first frequency is different from the second frequency. The digital radio further includes an output configured to provide the digital output signal to a target device, where the second data rate and the second frequency match a frequency plan of the target device.

### FIELD OF DISCLOSURE

The present disclosure relates to digital radios, and more particularly, to a digital radio with a programmable frequency plan emulator.

### BACKGROUND

Digital radio is the use of radio spectrum to transmit and receive digitally modulated signals. For example, a carrier signal can be modulated by a modulation signal that contains information encoded in a digital format. The modulated signal is then transmitted to a receiver, where the information is extracted from the modulated signal and passed onto another device for further processing.

### BRIEF DESCRIPTION OF THE DRAWINGS

FIG. 1 is a block diagram of a digital radio with a programmable frequency plan emulator, in accordance with an example of the present disclosure.

FIG. 2 is a block diagram of a signal processor of the digital radio of FIG. 1, in accordance with an example of the present disclosure.

FIG. 3 is a block diagram of a baseband rotator of the signal processor of FIG. 2, in accordance with an example of the present disclosure.

FIG. 4 is a block diagram of an interpolator of the signal processor of FIG. 2, in accordance with an example of the present disclosure.

FIG. 5 is a block diagram of an upconverter of the signal processor of FIG. 2, in accordance with an example of the present disclosure.

FIG. 6 is a block diagram of the clock domain crossing FIFO buffer of the signal processor of FIG. 2, in accordance with an example of the present disclosure.

FIG. 7 is a flow diagram of a methodology for processing a signal, in accordance with an example of the present disclosure.

Although the following detailed description will proceed with reference being made to illustrative examples, many alternatives, modifications, and variations thereof will be apparent in light of this disclosure.

### DETAILED DESCRIPTION

In accordance with an example of the present disclosure, a digital radio includes an input configured to receive an analog input signal and an analog-to-digital converter (ADC) configured to sample analog data in the analog input signal into a digital input signal. In an example, the analog input signal is a radio frequency (RF) signal from an antenna and the radio can include an RF front end that may amplify or filter the input signal. The RF front end also downconverts the analog input signal to a lower frequency band prior to the ADC. In another example, the analog input signal is provided directly to the ADC without downconversion. The digital input signal has first digital data encoded at a first data rate modulated at a first frequency. The digital radio further includes a signal processor configured to generate, based on the digital input signal, a digital output signal having second digital data encoded at a second data rate modulated at a second frequency. The first data rate is different from the second data rate and/or the first frequency is different from the second frequency. The digital radio further includes an output configured to provide the digital output signal to a target device, where the second data rate and the second frequency match a frequency plan of the target device.

In some examples, the signal processor includes one or more features that emulate, at the output of the digital radio, a data rate and a frequency modulation that matches the input data rate and frequency modulation of a downstream device. For example, the signal processor can include a signal preprocessor configured to process the digital input signal and to provide, at an output of the signal preprocessor, processed data at a digital data rate modulated at a digital intermediate frequency. Further, the signal processor includes a baseband rotator configured to relocate the output of the signal preprocessor to a baseband frequency and to provide, at an output of the baseband rotator, the processed data at the digital data rate modulated at the baseband frequency. Further, the signal processor includes an interpolator configured to convert the digital data rate of the output from the baseband rotator to an interpolated output having the second data rate modulated at the baseband frequency. Further, the signal processor includes an upconverter configured to upconvert the baseband frequency of the interpolated output of the interpolator to an upconverted output having the second data rate modulated at the second frequency. Further, the signal processor includes a clock domain crossing first-in-first-out (FIFO) buffer configured to meter, at an output of the clock domain crossing FIFO buffer, the digital output signal at the second data rate.

### General Overview

As noted above, a digital radio can perform digital processing on a radio frequency (RF) modulated signal and provide the processed data to a downstream processing unit. The radio outputs the processed data at a given data rate on a signal that is modulated by a given frequency. For example, a global navigation satellite system (GNSS) signal processor can provide a processed version of the GNSS signal to a downstream GNSS receiver. However, different GNSS receiver architectures may expect the data to be provided at data rates, and modulated by frequencies, that are different from those output by the GNSS signal processor. As used herein, GNNS is a broad term encompassing any type of satellite-based position, navigation, and timing (PNT) system and includes GPS, GLONASS, Baidu, Galileo, and any other constellation system.

For example, a digital radio downconverts an analog input signal from an RF frequency to an intermediate frequency (IF). The IF signal is then sampled by an analog-to-digital converter (ADC) at a given rate, followed by processing of the sampled signal. The signal processing can, in some instances, change the data sample rate by up-sampling or down-sampling the signal and/or change the intermediate frequency of the signal. The output of the signal processing to a downstream processor can thus be thought of as a stream of data at a sample rate F_{data} modulated at a frequency F_{digital_IF}. The parameters of the data (F_{data}, F_{digital_IF}) can be considered to be an output frequency plan of the digital radio.

The processing unit downstream of the digital radio has an input frequency plan that defines the data rate and modulation frequency of the expect input (F_{data_target}, F_{IF_target}). Therefore, if the output frequency plan of the digital radio and the input frequency plan of the downstream processing unit do not match, these devices will not be able to exchange information. In some examples, the digital radio that performs processing on the data has the output frequency plan (F_{data}, F_{digital_IF}) built-in, and any modifications to the output frequency plan may necessitate hardware changes, modifications to the digital signal processing algorithms, or both. However, it is difficult and expensive to modify the hardware and processing algorithms of the digital radio to collect and process data at multiple different rates and/or frequencies. As a result, the digital radio is typically paired with a downstream device having an input frequency plan that matches the output frequency plan of the radio because pairing the radio with a different, incompatible downstream device is unfeasible or impractical. This limits the range of downstream devices that can be paired with the digital radio, potentially excluding devices that would otherwise be preferable due to cost, features, performance, availability, or other factors.

To this end, in accordance with an example of the present disclosure, a digital radio is provided that further processes data to emulate a data rate and a frequency modulation of a downstream target device. That is, the radio emulates operation according to an input frequency plan of the target downstream device so that the output data stream of the radio matches the input data rate and frequency modulation of the target device, even though the radio and the target device operate at different data rates and/or at different modulation frequencies. In some examples, the digital radio includes a field programmable gate array (FPGA), application-specific integrated circuit (ASIC), or other discrete components and software that are configured to modify data that has been collected and processed with a given frequency plan to appear as if the data had been collected and processed using the frequency plan of the target device without changing hardware or the signal processing algorithms of the digital radio.

The data rate and frequency modulation of the output of the digital radio is emulated after the input signal is downconverted and processed according to a set of emulation parameters. The emulation includes internal feedback and dithered clocking that provide frequency tolerances that are tighter than that of the main clocks used to drive the radio, which helps maintain rounding and non-integer errors to negligible levels. In this manner, the digital radio can be adapted for integration with downstream devices and allows for the frequency plan to be chosen at the point of sale or implementation.

### Digital Radio With Programmable Frequency Plan Emulator

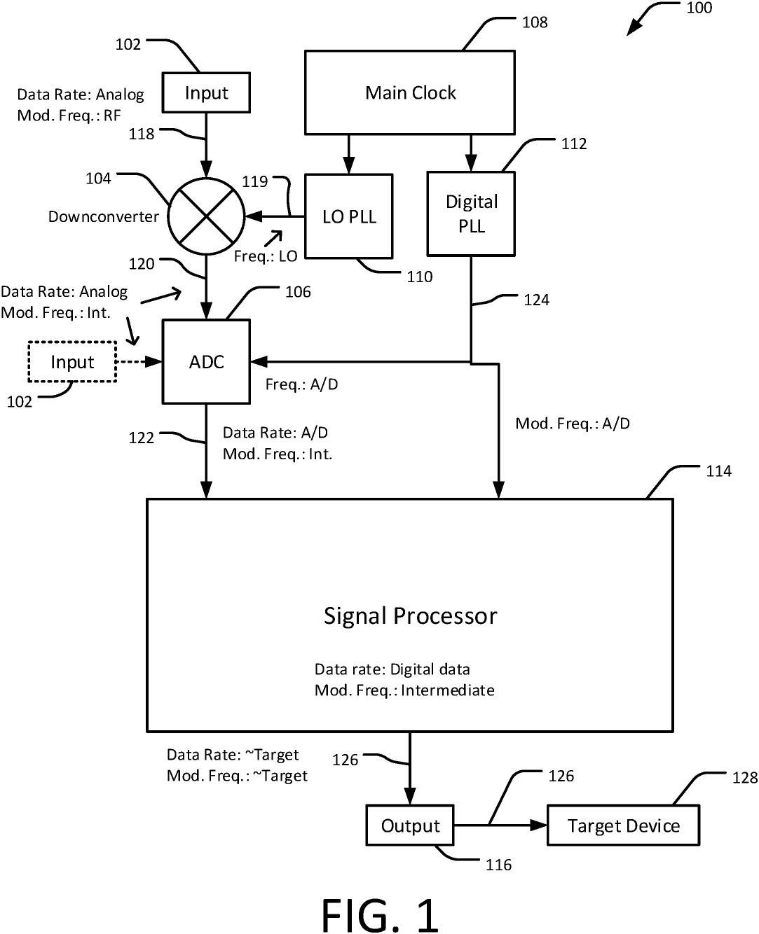

FIG. 1 is a block diagram of a digital radio 100 with a programmable frequency plan emulator, in accordance with an example of the present disclosure. The radio 100 includes an input 102, a downconverter 104, an analog-to-digital (ADC) converter 106, a main clock 108, a local oscillator (LO) phase lock loop (PLL) circuit 110, a digital PLL circuit 112, a signal processor 114, and an output 116.

The radio 100 is configured to receive an analog input signal 118 at the input 102. In one example the input 102 is coupled to an antenna or antenna array. In an example, the input signal 118 is an analog signal at an RF frequency. The RF front end may include amplifiers and filters (not shown) for the analog input signal 118. The downconverter 104 is configured to downconvert the analog input signal 118 to an intermediate frequency input signal 120, where the data in the input signal 118 has an intermediate frequency. The intermediate frequency is the RF frequency of the analog input signal 118 adjusted (reduced or increased, as the case may be) by an LO frequency 119 generated by the LO PLL circuit 110, which is clocked by the main clock 108 (e.g., intermediate frequency =|LO frequency - RF frequency|). One example of a downconverter is a mixer.

In another example, the analog input signal 118 has an intermediate frequency or other frequency that the ADC 106 is capable of processing. In this example, it is not necessary to downconvert the input signal 102. Instead, the input signal 102 can be directly provided to the ADC 106 or the downconverter 104 can effectively act as a pass-through without modifying the frequency of the analog input signal 118.

The ADC 106 samples the analog data from the intermediate frequency input signal 120 or the input signal 102 to produce a stream of digital data, which is encoded in a digital input signal 122 at an analog-to-digital (A/D) data rate modulated at the intermediate frequency. The ADC 106 is clocked using a digital PLL signal 124 generated by the digital PLL 112, which is clocked by the main clock 108, to provide the A/D data rate.

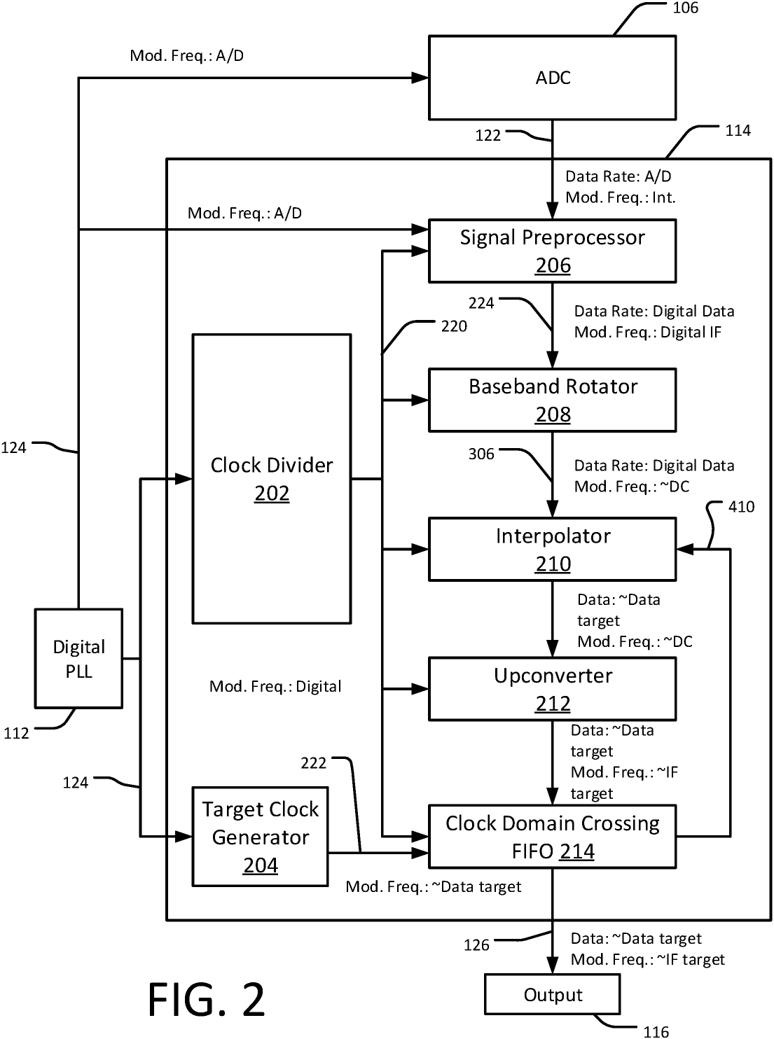

The signal processor 114 receives the digital input signal 122 and the digital PLL signal 124. The signal processor 114 produces a digital output signal 126 at the output 116. The digital output signal 126 provides a stream of processed digital data at a target data rate (or a data rate approximating the target data rate) modulated at a target frequency (or a frequency approximating the target frequency). The target data rate and the target modulation frequency correspond to the input frequency plan of a target device 128. Thus, in some cases, the target data rate of the output digital signal 126 is different from a digital data rate of at least some stages of the signal processor 114. In some cases, the target modulation frequency of the output digital signal 126 is different from the intermediate modulation frequency of the signal processor 114. In such cases, the signal processor 114 is configured to emulate processing the digital input signal 122 at the target data rate modulated at the target frequency, such as discussed in further detail with respect to FIGS. 2-6, to match the input frequency plan of the target device 128.

### Signal Processor

FIG. 2 is a block diagram of the signal processor 114 of the digital radio 100 of FIG. 1, in accordance with an example of the present disclosure. The signal processor 114 includes a clock divider 202, a target clock generator 204, a signal preprocessor 206, a baseband rotator 208, an interpolator 210, an upconverter 212, and a clock domain crossing first-in-first-out (FIFO) buffer 214.

The clock divider 202 is configured to divide the clock provided by the digital PLL 112 via the digital PLL signal 124 from a A/D modulation frequency into a clock signal 220 having a digital modulation frequency. The clock signal 220 output from the clock divider 202 is provided to the signal preprocessor 206, the baseband rotator 208, the interpolator 210, the upconverter 212, and the clock domain crossing FIFO buffer 214.

The target clock generator 204 is configured to generate a fractional PLL clock 222. In some examples, the target clock generator 204 can be implemented in an FPGA, an ASIC, or using discrete components. The fractional PLL clock 222 is used to generate the target data rate when the ratio between the A/D data rate and the target data rate is not an integer or a ratio that is reducible to a small integer. For example, the fractional PLL clock 222 can be represented as follows:

$${f}_{o u t} = \frac{{f}_{r e f}}{N} ∗ \left(M + \frac{K}{{2}^{32}}\right) ∗ \frac{1}{2 C}$$

where N, M, K, and C are frequency plan emulation parameters that can be selected to produce an output frequency accurate to approximately one part per trillion relative to the reference frequency f_{ref}. In this example, f_{ref} can be the A/D data rate and fₒᵤₜ can be the target data rate of the output digital signal 126. The fractional PLL clock 222 is used to clock the output of the clock domain crossing FIFO buffer 214.

The signal preprocessor 206 is configured to process the digital input signal 122. For example, the signal preprocessor 206 can be configured to extract information from the digital input signal 122 and to separate the I/Q (in-phase and quadrature) channels of the digital input signal 122. The output 224 of the signal preprocessor 206 provides the processed data at a digital data rate modulated at a digital intermediate frequency.

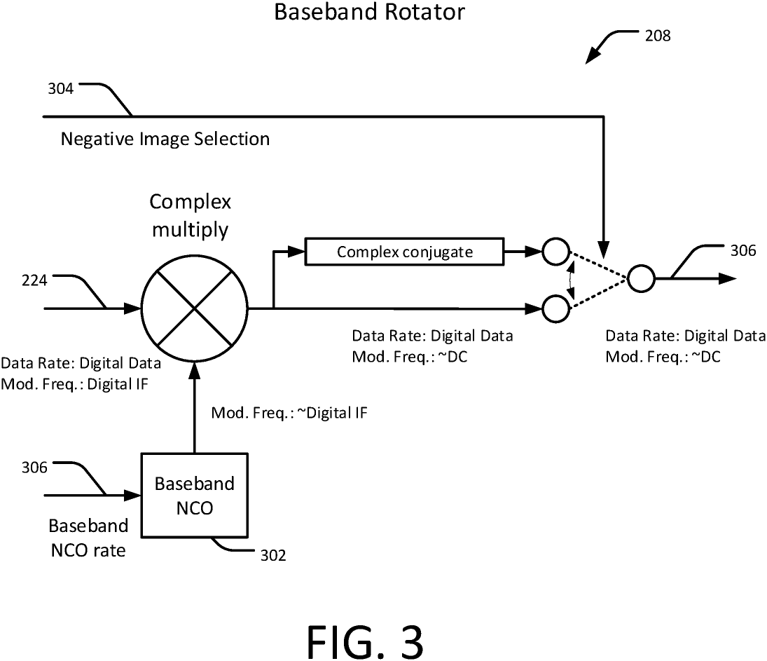

The baseband rotator 208 is configured to relocate the output 224 of the signal preprocessor 206 to a baseband frequency for more efficient processing. FIG. 3 is a block diagram of the baseband rotator 208, in accordance with an example of the present disclosure. Rotation is performed using quadrature mixing of the signal preprocessor output 224, which downconverts the digital intermediate modulation frequency to a baseband (~direct current (~DC)) modulation frequency using a 48-bit baseband numerically controlled oscillator (NCO) 302. The baseband NCO 302 essentially provides a set of complex exponential values at approximately the digital intermediate modulation frequency. The baseband rotator 208 uses two programmable frequency plan emulation parameters: negative image selection 304 and baseband NCO rate 306. The negative image selection 304 is a Boolean value used to select either a positive or negative signal image (via a complex conjugate) of the processed data to be output 306 at the digital data rate by the baseband rotator 208. The baseband NCO rate 306 can be selected based on the digital intermediate modulation frequency and the digital data rate of the signal output 224 from the signal preprocessor 206.

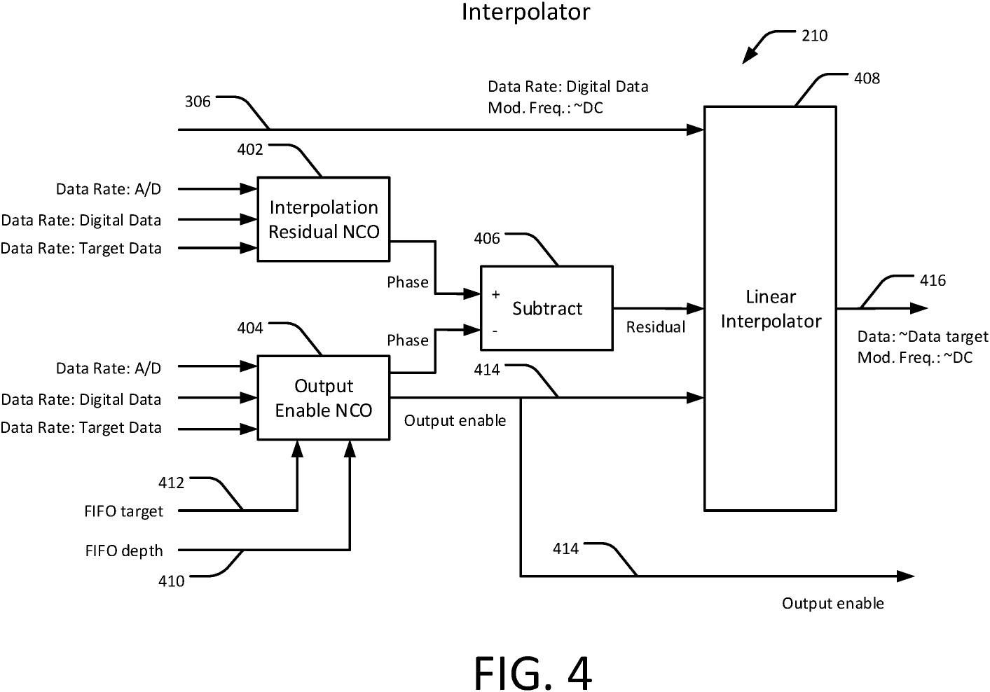

Referring again to FIG. 2, the interpolator 210 is configured to convert the signal output 306 of the baseband rotator 208 having the digital data rate modulated at the baseband frequency to an interpolated output 416 having a target data rate modulated at the baseband frequency. FIG. 4 is a block diagram of the interpolator 210, in accordance with an example of the present disclosure. The interpolator 210 includes an interpolation residual NCO 402, an output enable NCO 404, a subtractor 406, and a linear interpolator 408. The interpolation residual NCO 402 and the output enable NCO 404 each use three clock rates: the A/D data rate, the digital data rate, and the target data rate. The output enable NCO 404 further uses a FIFO target depth value 410, which is set to half of a depth 412 of the clock domain crossing FIFO 214. Because the target data rate used here and the approximate target data rate produced by the target clock generator 204 may not be exactly the same, an output enable NCO 404 includes a proportional-integral-derivative (PID) controller that drives the interpolation to keep the current FIFO depth at a target value to ensure that the data is produced at the exact same rate that it is consumed out of the clock domain crossing FIFO 214. Phases output by the interpolation residual NCO 402 and the output enable NCO 404 each enter the subtractor 406, which provides a residual value to the linear interpolator 408. An output enable signal 414 provides a pulse to the linear interpolator 408 that runs at the digital data rate but is dithered to be active in aggregate at the target data rate.

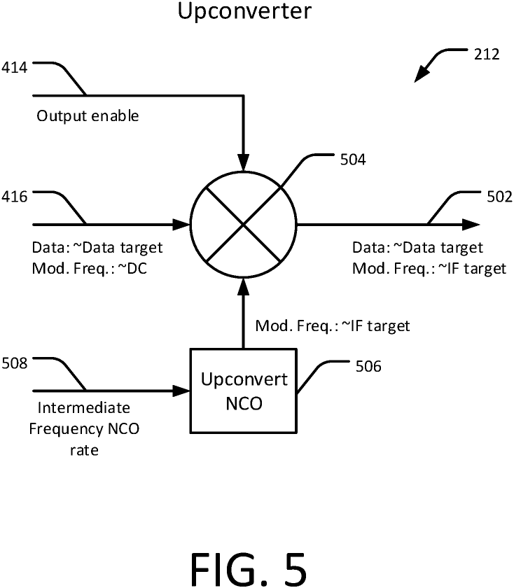

Referring again to FIG. 2, the upconverter 212 is configured to upconvert the baseband (~DC) frequency of the interpolated output 416 of the interpolator 210 to an upconverted output 502 having the processed data at the target data rate modulated at an intermediate target frequency, such as shown in FIG. 5. FIG. 5 is a block diagram of the upconverted 212, in accordance with an example of the present disclosure. The upconverted 212 includes a mixer 504 and an upconvert NCO 506. The upconvert NCO 506 uses a programmable intermediate frequency NCO rate value 508 to generate the upconvert frequency to the mixer 504. The NCO rate value 508 can be selected based on the target intermediate frequency and the target data rate frequency. The mixer 504 operates at the digital data rate but is only activated at the dithered rate of approximately the target data rate provided by the output enable signal 414 from the interpolator 210.

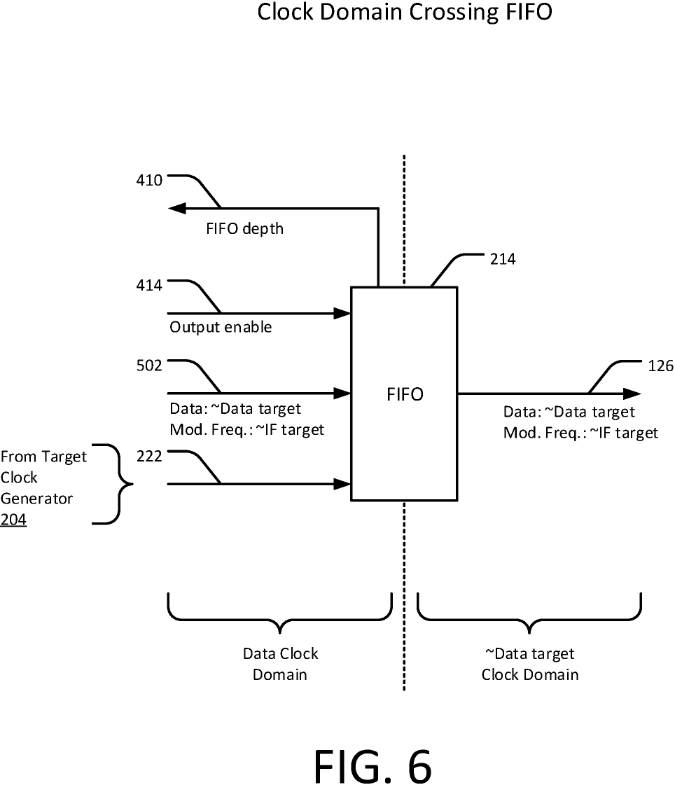

Referring again to FIG. 2, the clock domain crossing FIFO buffer 214 is configured to meter or otherwise regulate the digital output signal 126 at the output 116 to the desired target data rate such that the target data rate emulates (matches) the frequency plan of the target device 128. FIG. 6 is a block diagram of the clock domain crossing FIFO buffer 214, in accordance with an example of the present disclosure. The clock domain crossing FIFO buffer 214 is clocked by the fractional PLL clock 222 from the target clock generator 204. Logic in the data clock domain operates at the digital data rate but is only activated for writing at the dithered rate of approximately the target data rate provided by the output enable signal from the interpolator 210. Logic in the data target clock domain operates at approximately the target data rate. The FIFO depth 410, which is fed back to the interpolator 210, ensures that the clock domain crossing FIFO 214 is filled at exactly the same rate as it is emptied.

### Signal Processing Methodology

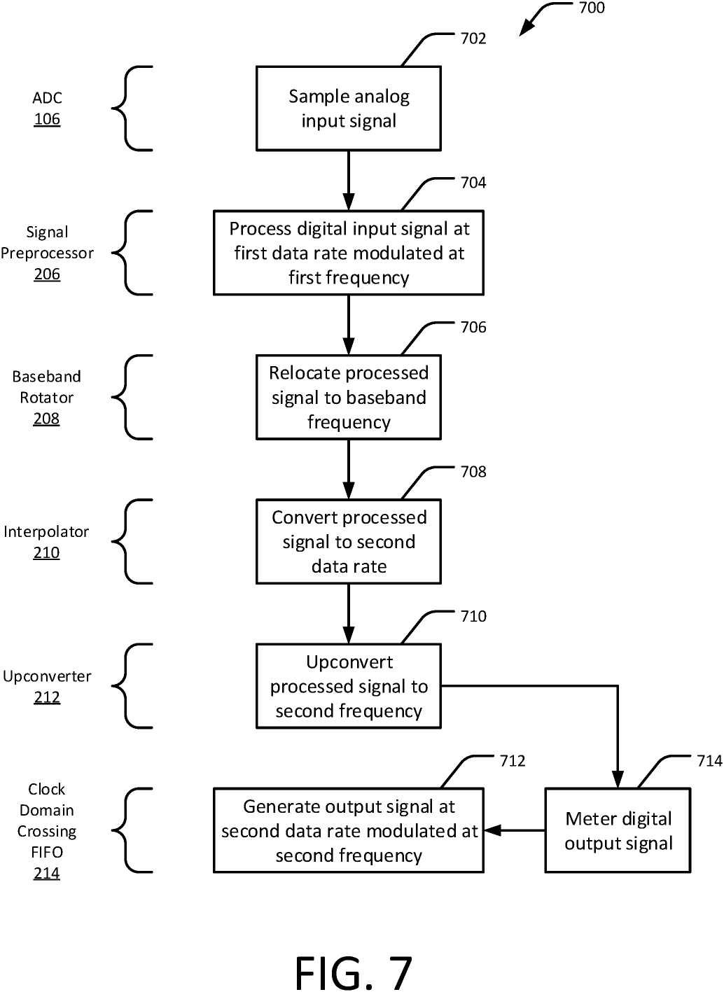

FIG. 7 is a flow diagram of a methodology 700 for processing a signal, in accordance with an example of the present disclosure. The methodology 700 can be implemented, for example, in the digital radio 100 of FIG. 1. The methodology 700 includes sampling 702, by an analog-to-digital converter (ADC), analog data in an analog input signal into a digital input signal having first digital data encoded at a first data rate modulated at a first frequency; and generating 712, by a signal processor and based on the digital input signal, a digital output signal having second digital data encoded at a second data rate modulated at a second frequency, wherein the first data rate is different from the second data rate and/or the first frequency is different from the second frequency.

In some examples, the methodology 700 further includes processing 704, by a signal preprocessor, the digital input signal and providing, at an output of the signal preprocessor, processed data at a digital data rate modulated at a digital intermediate frequency. In some examples, the methodology 700 further includes relocating 706, by a baseband rotator, the output of the signal preprocessor to a baseband frequency and providing, at an output of the baseband rotator, the processed data at the digital data rate modulated at the baseband frequency. In some examples, the methodology 700 further includes converting 708, by an interpolator, the digital data rate of the output from the baseband rotator to an interpolated output having the second data rate modulated at the baseband frequency. In some examples, the methodology 700 further includes upconverting 710, by an upconverter, the baseband frequency of the interpolated output of the interpolator to an upconverted output having the second data rate modulated at the second frequency. In some examples, the methodology 700 further includes metering 714, by a clock domain crossing first-in-first-out (FIFO) buffer, at an output of the clock domain crossing FIFO buffer, the digital output signal at the second data rate.

### Further Examples

The following examples pertain to further examples, from which numerous permutations and configurations will be apparent.

Example 1 provides a digital radio, including an input configured to receive an analog signal; an analog-to-digital converter (ADC) configured to sample analog data in the analog input signal into a digital input signal having first digital data encoded at a first data rate modulated at a first frequency; a signal processor configured to generate, based on the digital input signal, a digital output signal having second digital data encoded at a second data rate modulated at a second frequency, wherein the first data rate is different from the second data rate and/or the first frequency is different from the second frequency; and an output configured to provide the digital output signal to a target device, wherein the second data rate and the second frequency match a frequency plan of the target device.

Example 2 includes the subject matter of Example 1, wherein the signal processor comprises clock domain crossing first-in-first-out (FIFO) buffer configured to meter, at an output of the clock domain crossing FIFO buffer, the digital output signal at the second data rate.

Example 3 includes the subject matter of Example 2, wherein the signal processor further comprises a signal preprocessor configured to process the digital input signal and to provide, at an output of the signal preprocessor, processed data at a digital data rate modulated at a digital intermediate frequency.

Example 4 includes the subject matter of Example 3, wherein the signal processor further comprises a baseband rotator configured to relocate the output of the signal preprocessor to a baseband frequency and to provide, at an output of the baseband rotator, the processed data at the digital data rate modulated at the baseband frequency.

Example 5 includes the subject matter of Example 4, wherein the signal processor further comprises an interpolator configured to convert the digital data rate of the output from the baseband rotator to an interpolated output having the second data rate modulated at the baseband frequency.

Example 6 includes the subject matter of Example 5, wherein the signal processor further comprises an upconverter configured to upconvert the baseband frequency of the interpolated output of the interpolator to an upconverted output having the second data rate modulated at the second frequency.

Example 7 includes the subject matter of Example 6, wherein the signal processor further comprises a clock generator configured to generate a fractional phase lock look (PLL) clock for clocking the output of the clock domain crossing FIFO buffer.

Example 8 includes the subject matter of any one of Examples 1-7, further comprising a digital phase lock loop (PLL) clock configured to clock the ADC.

Example 9 provides a method of processing a signal, the method including sampling, by an analog-to-digital converter (ADC), analog data in an analog input signal into a digital input signal having first digital data encoded at a first data rate modulated at a first frequency; and generating, by a signal processor and based on the digital input signal, a digital output signal having second digital data encoded at a second data rate modulated at a second frequency, wherein the first data rate is different from the second data rate and/or the first frequency is different from the second frequency.

Example 10 includes the subject matter of Example 9, further including metering, by a clock domain crossing first-in-first-out (FIFO) buffer, at an output of the clock domain crossing FIFO buffer, the digital output signal at the second data rate.

Example 11 includes the subject matter of Example 10, further including processing, by a signal preprocessor, the digital input signal and providing, at an output of the signal preprocessor, processed data at a digital data rate modulated at a digital intermediate frequency.

Example 12 includes the subject matter of Example 11, further including relocating, by a baseband rotator, the output of the signal preprocessor to a baseband frequency and providing, at an output of the baseband rotator, the processed data at the digital data rate modulated at the baseband frequency.

Example 13 includes the subject matter of Example 12, further including converting, by an interpolator, the digital data rate of the output from the baseband rotator to an interpolated output having the second data rate modulated at the baseband frequency.

Example 14 includes the subject matter of Example 13, further including upconverting, by an upconverter, the baseband frequency of the interpolated output of the interpolator to an upconverted output having the second data rate modulated at the second frequency.

Example 15 includes the subject matter of Example 14, further including generating, by a clock generator, a fractional phase lock look (PLL) clock for clocking the output of the clock domain crossing FIFO buffer.

Example 16 provides a computer program product including one or more non-transitory machine-readable mediums encoded with instructions that when executed by one or more processors cause a process to be carried out for processing a signal, the process including sampling, by an analog-to-digital converter (ADC), analog data in an analog input signal into a digital input signal having first digital data encoded at a first data rate modulated at a first frequency; and generating, by a signal processor and based on the digital input signal, a digital output signal having second digital data encoded at a second data rate modulated at a second frequency, wherein the first data rate is different from the second data rate and/or the first frequency is different from the second frequency.

Example 17 includes the subject matter of Example 16, wherein the process further includes metering, by a clock domain crossing first-in-first-out (FIFO) buffer, at an output of the clock domain crossing FIFO buffer, the digital output signal at the second data rate.

Example 18 includes the subject matter of Example 17, wherein the process further includes processing, by a signal preprocessor, the digital input signal and providing, at an output of the signal preprocessor, processed data at a digital data rate modulated at a digital intermediate frequency.

Example 19 includes the subject matter of Example 18, wherein the process further includes relocating, by a baseband rotator, the output of the signal preprocessor to a baseband frequency and providing, at an output of the baseband rotator, the processed data at the digital data rate modulated at the baseband frequency.

Example 20 includes the subject matter of Example 19, wherein the process further includes converting, by an interpolator, the digital data rate of the output from the baseband rotator to an interpolated output having the second data rate modulated at the baseband frequency; upconverting, by an upconverter, the baseband frequency of the interpolated output of the interpolator to an upconverted output having the second data rate modulated at the second frequency; and generating, by a clock generator, a fractional phase lock look (PLL) clock for clocking the output of the clock domain crossing FIFO buffer.

Some examples may be described using the expression “coupled” and “connected” along with their derivatives. These terms are not intended as synonyms for each other. For example, some examples may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The examples are not limited in this context.

The terms “circuit” or “circuitry,” as used in any example herein, are functional structures that include hardware, or a combination of hardware and software, and may comprise, for example, singly or in any combination, hardwired circuitry, programmable circuitry such as computer processors comprising one or more individual instruction processing cores, state machine circuitry, and/or gate level logic. The circuitry may include a processor and/or controller programmed or otherwise configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other examples may be implemented as software executed by a programmable device. In any such hardware cases that include executable software, the terms “circuit” or “circuitry” are intended to include a combination of software and hardware such as a programmable control device or a processor capable of executing the software. As described herein, various examples may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the examples. It will be understood, however, that other examples may be practiced without these specific details, or otherwise with a different set of details. It will be further appreciated that the specific structural and functional details disclosed herein are representative of examples and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

What is claimed is:

1. A digital radio, comprising:
an input configured to receive an analog input signal;
an analog-to-digital converter (ADC) configured to sample analog data in the analog input signal into a digital input signal having first digital data encoded at a first data rate modulated at a first frequency;
a signal processor configured to generate, based on the digital input signal, a digital output signal having second digital data encoded at a second data rate modulated at a second frequency, wherein the first data rate is different from the second data rate, the first frequency is different from the second frequency, or both; and
an output configured to provide the digital output signal to a target device, wherein the second data rate and the second frequency match a frequency plan of the target device.

2. The digital radio of claim 1, wherein the signal processor comprises a clock domain crossing first-in-first-out (FIFO) buffer configured to meter, at an output of the clock domain crossing FIFO buffer, the digital output signal at the second data rate.

3. The digital radio of claim 2, wherein the signal processor further comprises a signal preprocessor configured to process the digital input signal and to provide, at an output of the signal preprocessor, processed data at a digital data rate modulated at a digital intermediate frequency.

4. The digital radio of claim 3, wherein the signal processor further comprises a baseband rotator configured to relocate the output of the signal preprocessor to a baseband frequency and to provide, at an output of the baseband rotator, the processed data at the digital data rate modulated at the baseband frequency.

5. The digital radio of claim 4, wherein the signal processor further comprises an interpolator configured to convert the digital data rate of the output from the baseband rotator to an interpolated output having the second data rate modulated at the baseband frequency.

6. The digital radio of claim 5, wherein the signal processor further comprises an upconverter configured to upconvert the baseband frequency of the interpolated output of the interpolator to an upconverted output having the second data rate modulated at the second frequency.

7. The digital radio of claim 6, wherein the signal processor further comprises a clock generator configured to generate a fractional phase lock look (PLL) clock for clocking the output of the clock domain crossing FIFO buffer.

8. The digital radio of claim 1, further comprising a digital phase lock loop (PLL) clock configured to clock the ADC.

9. A method of processing a signal, the method comprising:
sampling, by an analog-to-digital converter (ADC), analog data in an analog input signal into a digital input signal having first digital data encoded at a first data rate modulated at a first frequency; and
generating, by a signal processor and based on the digital input signal, a digital output signal having second digital data encoded at a second data rate modulated at a second frequency, wherein the first data rate is different from the second data rate, the first frequency is different from the second frequency, or both.

10. The method of claim 9, further comprising metering, by a clock domain crossing first-in-first-out (FIFO) buffer, at an output of the clock domain crossing FIFO buffer, the digital output signal at the second data rate.

11. The method of claim 10, further comprising processing, by a signal preprocessor, the digital input signal and providing, at an output of the signal preprocessor, processed data at a digital data rate modulated at a digital intermediate frequency.

12. The method of claim 11, further comprising relocating, by a baseband rotator, the output of the signal preprocessor to a baseband frequency and providing, at an output of the baseband rotator, the processed data at the digital data rate modulated at the baseband frequency.

13. The method of claim 12, further comprising converting, by an interpolator, the digital data rate of the output from the baseband rotator to an interpolated output having the second data rate modulated at the baseband frequency.

14. The method of claim 13, further comprising upconverting, by an upconverter, the baseband frequency of the interpolated output of the interpolator to an upconverted output having the second data rate modulated at the second frequency.

15. The method of claim 14, further comprising generating, by a clock generator, a fractional phase lock look (PLL) clock for clocking the output of the clock domain crossing FIFO buffer.

16. A computer program product including one or more non-transitory machine-readable mediums encoded with instructions that when executed by one or more processors cause a process to be carried out for processing a signal, the process comprising:
sampling, by an analog-to-digital converter (ADC), analog data in an analog input signal into a digital input signal having first digital data encoded at a first data rate modulated at a first frequency; and
generating, by a signal processor and based on the digital input signal, a digital output signal having second digital data encoded at a second data rate modulated at a second frequency, wherein the first data rate is different from the second data rate, the first frequency is different from the second frequency, or both.

17. The computer program product of claim 16, wherein the process further comprises metering, by a clock domain crossing first-in-first-out (FIFO) buffer, at an output of the clock domain crossing FIFO buffer, the digital output signal at the second data rate.

18. The computer program product of claim 17, wherein the process further comprises processing, by a signal preprocessor, the digital input signal and providing, at an output of the signal preprocessor, processed data at a digital data rate modulated at a digital intermediate frequency.

19. The computer program product of claim 18, wherein the process further comprises relocating, by a baseband rotator, the output of the signal preprocessor to a baseband frequency and providing, at an output of the baseband rotator, the processed data at the digital data rate modulated at the baseband frequency.

20. The computer program product of claim 19, wherein the process further comprises:
converting, by an interpolator, the digital data rate of the output from the baseband rotator to an interpolated output having the second data rate modulated at the baseband frequency;
upconverting, by an upconverter, the baseband frequency of the interpolated output of the interpolator to an upconverted output having the second data rate modulated at the second frequency; and
generating, by a clock generator, a fractional phase lock look (PLL) clock for clocking the output of the clock domain crossing FIFO buffer.
